(19) United States
(12) Patent Application Publication
(10) Pub. No.: US 2013/0117064 A1
(43) Pub. Date: May 9, 2013

(54) BUSINESS PROCESS ANALYSIS COMBINING MODELING, SIMULATION AND COLLABORATION WITH WEB AND CLOUD DELIVERY

(71) Applicants: Kamyar SADEGHI, Tiburon, CA (US); Steve WILBER, Menlo Park, CA (US); Anup KALLINGAL, Mumbai (IN); Colin W. MACNAUGHTON, San Francisco, CA (US)

(72) Inventors: Kamyar SADEGHI, Tiburon, CA (US); Steve WILBER, Menlo Park, CA (US); Anup KALLINGAL, Mumbai (IN); Colin W. MACNAUGHTON, San Francisco, CA (US)

(73) Assignee: PROGRESS SOFTWARE CORPORATION, Bedford, MA (US)

(21) Appl. No.: 13/494,150

(22) Filed: Jun. 12, 2012

Related U.S. Application Data
(60) Provisional application No. 61/498,280, filed on Jun. 17, 2011.

(51) Int. Cl. G06Q 10/06

(52) U.S. Cl. CPC G06Q 10/0633
USPC 705/7.27

(57) ABSTRACT

A business process analysis system provides a platform for process modeling and simulation in a collaborative environment. The system includes a series of client stations connected to servers over a network. The platform is suitable for operating on an internal, local enterprise network or a group of systems across multiple locations, or in a cloud-based or other environment. The servers maintain business process models being created or edited at one or more clients. The servers also run simulations of the models. A collaboration server controls changes to the business process model. A history of revisions is maintained in a content management system. An interactive work site provides relevant information regarding the business process models, such as a listing of the latest changes to the model, user-submitted commentary, discussions, and additional files relating to the model.

### PRIORITY

This application claims priority to U.S. Provisional Application No. 61/498280, filed Jun. 17, 2011.

### FIELD OF THE DISCLOSURE

This disclosure relates to a system and method of providing a collaborative business process analysis and simulation platform. The platform is suitable for operating on an internal, local enterprise network or a group of systems across multiple locations, or in a cloud-based or other environment.

### BACKGROUND

Business process management systems permit companies to model, analyze, or automate their processes. For example, Progress Software Corporation of Bedford, MA provides a business process management system, known as Savvion, which allows for business process simulation and modeling, enabling the design and analysis of process models. Business process analysis (BPA) tools enable the creation and analysis of a process model in order to, for example, identify process bottlenecks, satisfy Service Level Agreement requirements, address resource requirements, and estimate costs.

Existing BPA simulation tools are typically expensive, complex, and computationally intensive, and not accessible to most users. These existing BPA tools lack editing capabilities that enable process discovery via collaborative development. Further, these existing BPA tools lack the ability to collaborate on defining and reviewing simulation scenarios.

### SUMMARY

A Web-enabled BPA system provides a platform for process modeling and simulation in a collaborative environment in which data within the system is available through a network link. The platform is suitable for operating on an internal, local enterprise network or a group of systems across multiple locations, or in a cloud-based or other environment. The collaborative ability of the BPA system allows multiple users to jointly develop process models, add comments, attach documents, and define process worksteps. An interactive work site provides information regarding the business process models, such as a listing of the latest changes to the model, user-submitted commentary, discussions, and files relating to the model. Additionally, the BPA system can perform process simulation, allowing for the detection of design flaws, process improvement, identification of bottlenecks, and estimation of costs. Users can generate simulation reports that indicate resource utilization, provide time and cost analysis, and suggest corrective actions. The cloud-optimized BPA system provides a process repository for automatic versioning, revision history, and process sharing.

In some embodiments, a BPA system includes a first server that provides a user interface for a plurality of clients and a second server, in communication with the first server, that stores business process models in a content management system. The user interface permits the creation and editing of a business process model, and permits a plurality of users to edit the same business process model simultaneously.

In some embodiments, the BPA system provides for synchronizing changes to a business process model across a plurality of clients. One or more users may each apply a different change to a business process model, and then send a command to a server to update the business process model. In response to the command, the server synchronizes a local copy of the business process model with a version of the business process model stored in a content management system. The first server then determines a validity of the change to the business process model against the synchronized local copy of the business process model. If the change is determined to be valid, the server provides a new version of the business process model incorporating the change to the content management system.

In some embodiments, the BPA system can run simulations based on a business process model. To run simulations, the BPA system receives a simulation request specifying a business process model on which to perform the simulation. The BPA system then prepares simulation data in response to the received simulation request, configures parameters of the simulation, creates a simulation engine object, and passes the simulation data to the simulation engine object. The BPA system then processes a series of worksteps to execute the simulation and generate simulation results. The BPA system stores the simulation results and may also generate reports based on the simulation results.

### BRIEF DESCRIPTION OF THE DRAWINGS

FIG. 1 shows an exemplary BPA system in accordance with an embodiment of the present invention.

FIG. 2 shows an exemplary BPA server in accordance with an embodiment of the present invention.

FIG. 3 shows a flow chart identifying steps in running a simulation from a business process model in accordance with an embodiment of the present invention.

FIG. 4 shows user-interface elements used to collaboratively design a business process model in a BPA system in accordance with an embodiment of the present invention.

FIG. 5 shows a representation of a business process model with phases in accordance with an embodiment of the present invention.

FIG. 6 shows a representation of a business process model with swim lanes in accordance with an embodiment of the present invention.

### DETAILED DESCRIPTION

### System Architecture

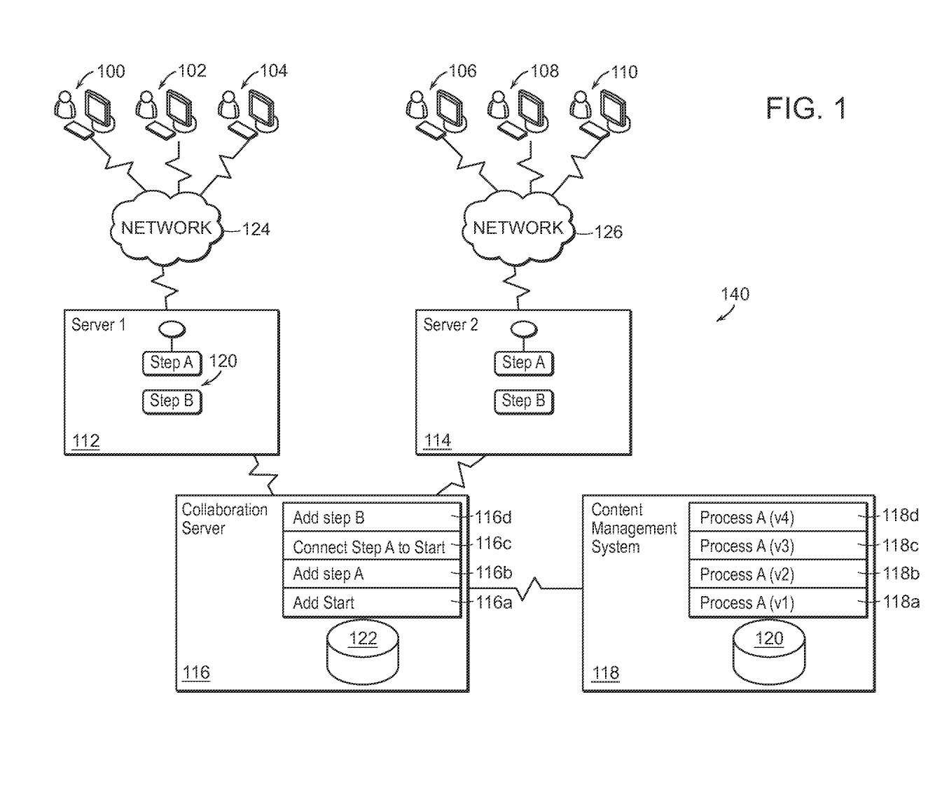

An exemplary BPA system 140 is shown in FIG. 1. The system 140 includes clients 100, 102, 104, 106, 108 and 110, connected via the Internet or other computer network 124 or 126, to BPA servers 112 and 114. Although shown as separate networks, it should be understood that a single network can be used to connect clients 100-110 to BPA servers 112 and 114. BPA servers 112 and 114 are also connected to collaboration server 116 via the Internet or other computer network. Collaboration server 116 is also connected to content management system 118 via the Internet or other computer network. In some embodiments, BPA system 140 is cloud-based, involving the use of shared computer resources accessible across computers. The cloud platform may be provided by the enterprise or through a cloud provider, such as Amazon's Elastic Computer Cloud (EC2). In certain embodiments, BPA system 140 may involve an internal, local enterprise network or a network spread across multiple enterprise locations. Clients 100-110 include a web browser application, such as Internet Explorer or Mozilla Firefox, as known in the art, to access a user interface provided by the BPA system in order to create business process models on BPA servers 112 and 114. BPA system 140 is scalable to allow for the use of one or more BPA servers, collaboration servers, or content management systems as appropriate for a specific implementation. A user at one of clients 100-110, responsible for creating and overseeing the development of the process model, can assign each user access rights to the model, simulations, and related data.

BPA servers 112 and 114 provide users using the web browser application at clients 100-110 with a user interface allowing the users to design and view a business process model, such as business process model 120 illustrated at server 112. Once created, business process model 120 is stored in content management system 118, from which the business process model is accessible by an authorized user at any client 100-110 connected to the BPA system.

The collaborative nature of the BPA system shown in FIG. 1 facilitates multiple users editing a single process model at the same time. Each user's local system (e.g., client 100), or node, keeps a local copy of the business process model in memory. This local copy is used to render the process to the user and can be used to make changes to the business process model.

Changes made to a business process model are stored back to process repository 120 in content management system 118 through BPA server 112 or 114, and collaboration server 116. In particular, in some embodiments, every user change is not immediately stored as a new version of the business process model in the content management system 118. Rather, each user's edit to the business process model is registered at the corresponding server and recorded as a “command” at collaboration server 116. Storing this sequence of commands allows reconstructing the state of a process diagram without loss of any data. In some embodiments, content management system 118 only stores a new version of the business process model when either (1) a configurable setting determines that a version should be saved, for example every 5 minutes, or (2) a user instructs the content management system 118 to take a snapshot of the process. Once a new version is saved into the content management system, the command list is cleared and awaits the next user submitted change. Content management system 118 stores a sequence of versions of the collaboratively developed process models, shown as 118a-118d in FIG. 1.

In order to ensure process model consistency across all users, each user's system periodically makes a call to the BPA server 112 or 114 with which that client is communicating, to request the latest changes with a revision number later than the client's current revision number. The BPA server responds to this user request by sending all changes with a revision number later than the user's model's revision number that did not originate from the requesting user. Upon receipt, the user's system updates the local model contained in memory and displayed in their browser in accordance with the revisions sent by the BPA server. Additionally or alternatively, other data update methods, such as event driven updates initated by the server, may be used.

Changes applied to a business process model by a user, such as a user at client 100, are registered in a database 122 controlled by collaboration server 116. When a user makes a change to the process model in their browser, that change must be approved by the associated server 112 or 114 before it is applied to the local model stored in the client's memory. Each change is sent to the BPA server as a command that contains the old and new parts of the model being changed. Prior to attempting to apply the change, BPA server 112 or 114 synchronizes its local copy of the model with the version contained in content management system 118. This allows BPA server 112 or 114 to confirm it is validating changes against the most up to date view of the model. At this time, collaboration server 116 provides a write lock to the BPA server to prevent other BPA servers from simultaneously attempting to apply a change (command) that may conflict. The server executes the code to determine the validity of the proposed change against its model. If the change is determined to be valid, the command is recorded by collaboration server 116, the write lock is released, and the change is applied. The server informs the user responsible for submitting the change as to the result of the proposed change. If the change is not valid, the write lock is released without the command being applied and the user is informed of the conflict. BPA servers 112 and 114 also receive updates of commands applied by clients on other BPA servers within BPA system 140 via the collaboration server 116. Multiple users can make changes to a business process model at the same time, with all the changes being valid and applied if they do not conflict. For example, a change to the beginning of a business process model made by one user may not conflict with a change to the end of the business process model made by another user. This allows, for example, for a user at client 108 accessing BPA system 140 via BPA server 116 to make a change to a business process model and have it validated and propogated to a user at client 102 connected via BPA server 112.

### Business Process Modeling

The interface accessed by the user's web browser is provided by the BPA server 112 or 114. To create and edit business process models, a user interacts with the interface to drag and drop shapes representative of business activities. The interface is accessed by clients 100-110 by logging in to the BPA system via a homepage, which provides the option to create a new process. In creating the process, the user in some embodiments will name the process model, and is allowed to include a textual description of the model and keywords which can be used when searching for process models within the BPA system. When the user has entered this information, a blank process model is created in the user interface, which can be modified by the user. The user responsible for creating the process model can assign access rights to other users of the BPA system. Such access rights control the other users' ability to write and read the process model itself, as well as attendant data.

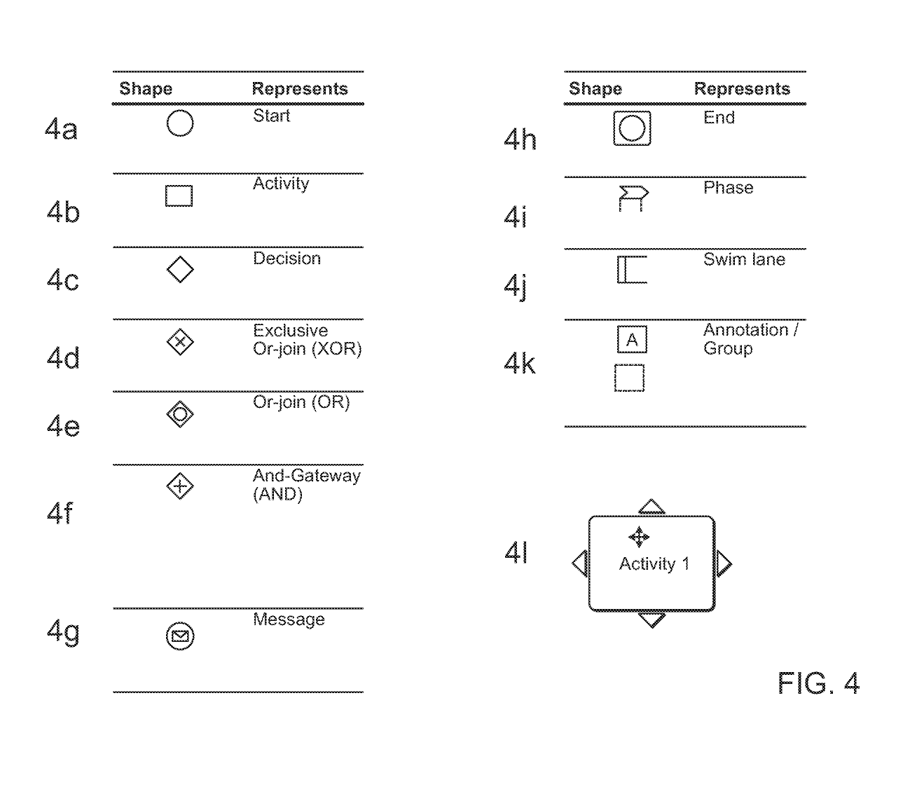

By using the user interface, users at clients 100-110 specify the work flow, that is, the joining, merging, splitting or deciding of a work flow's direction. FIG. 4 depicts shapes 4a-4k used in modeling business processes in accordance with some embodiments. The Start 4a and End 4h shapes, for example, are event objects that specify the beginning and end of a business process. Each process will have one Start shape. In some embodiments, a business process can have multiple End worksteps, each signifying an end to the process. Activity shape 4b represents the basic unit of work that can be assigned to a performer. A performer can be a human performer, a group of human performers, a system, or a subprocess.

Decision shape 4c, Exclusive OR-join shape 4d, OR-join shape 4e, and AND shape 4f are gateways that indicate a change in the work flow, such as the joining, merging, splitting or deciding of the flow's direction. Decision shape 4c represents a decision point in the process flow, the decision being based on specified conditions and having a conditional branch and a default branch. If the specified condition is met, the conditional branch is taken. If the specified condition is not met, the default branch is taken. Exclusive OR-join 4d enables the process flow to proceed only once from multiple predecessor worksteps to a successor workstep, and terminates any other human-performed predecessor worksteps. OR-join 4e connects multiple predecessor worksteps and one successor workstep. The successor workstep is performed if any of the predecessor worksteps have been completed. AND 4f can act as an AND join or as a split (or AND-fork). When AND 4f connects multiple worksteps to a single successor workstep, it acts as an AND-join. When AND 4f connects one predecessor workstep to multiple successor worksteps, it acts as a split (AND-fork). The successor worksteps are performed in parallel and only if the predecessor was completed. The AND gateway allows the completion of multiple predecessor worksteps to be synchronized.

Message shape 4g represents an intermediate workstep in a process and indicates that the workstep is waiting for a message, or will send a message when it is activated. Messages also can be assigned to Start 4a and End 4h worksteps.

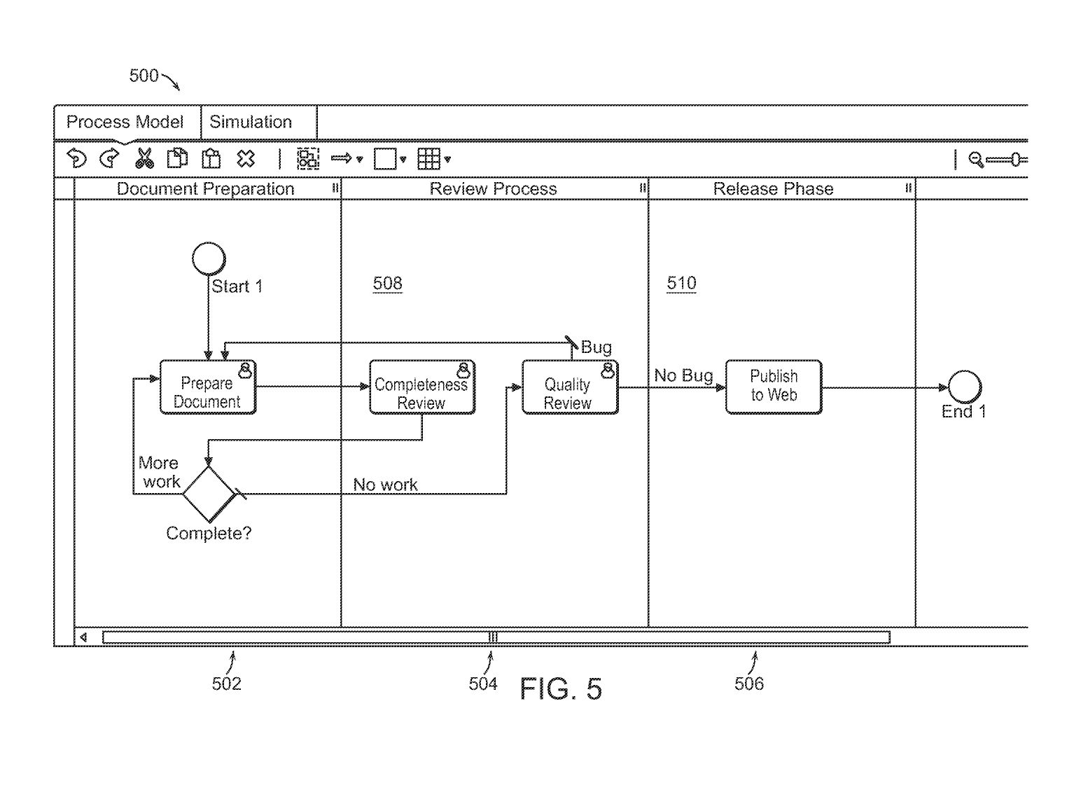

Phase shape 4i allows a user to divide worksteps into groups of tasks. These groups of one or more worksteps may signify the completion of a process segment (or “phase”). For example, in a sales process, all subtasks that help achieve customer prospecting might be considered a phase. As illustrated in FIG. 5, business process model 500 has three phases, 502, 504, 506, separated by vertical lines 508 and 510 as represented in the user interface. In this example, phase 502 has been provided the name “Document Preparation,” phase 504 has been provided the name “Review Process,” and phase 506 has been provided the name “Release Phase.”

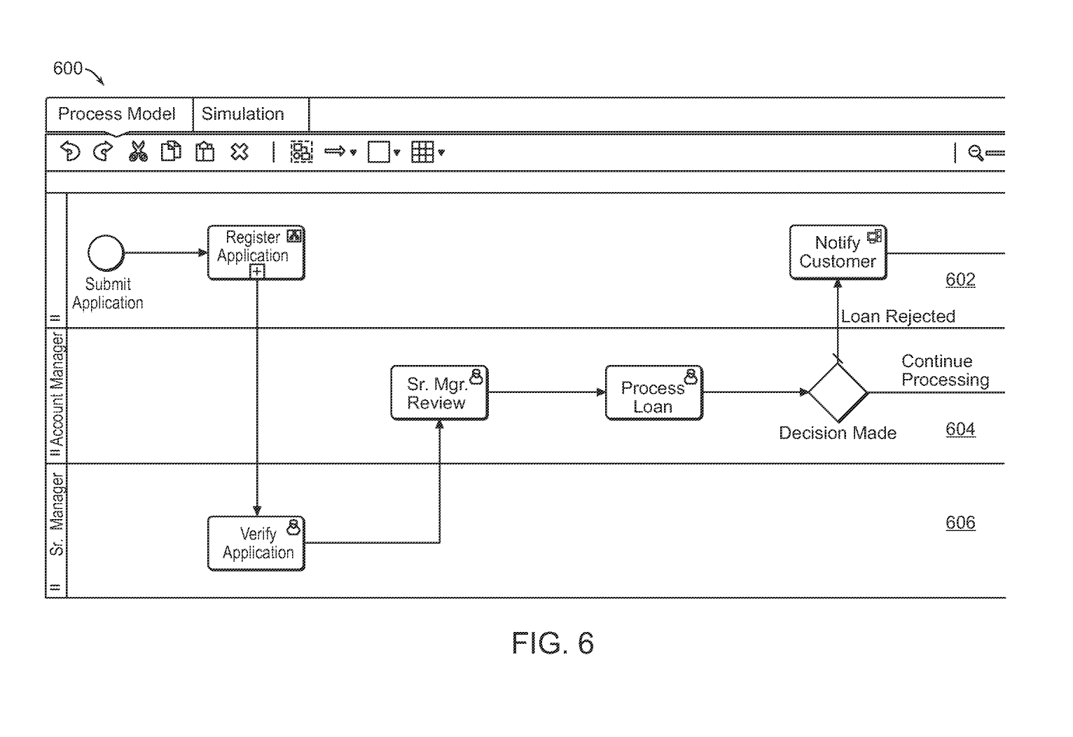

Swim lane shape 4j groups all worksteps performed by a specific human performer. An exemplary swim lane is illustrated in FIG. 6, with business process model 600 having three swim lanes, 602, 604, and 606. Swim lane 602 does not have a specified performer and any worksteps included in swim lane 602 will retain its original performer. Swim lane 604 is associated with an account manager performer, and swim lane 606 is associated with a senior manager performer. If an additional workstep were to be added to swim lane 604 or 606, it would be assigned the designated performer. Similarly, if a workstep were to be moved from one swim lane to another, the performer would be updated to reflect the designated performer (if any) for that swim lane.

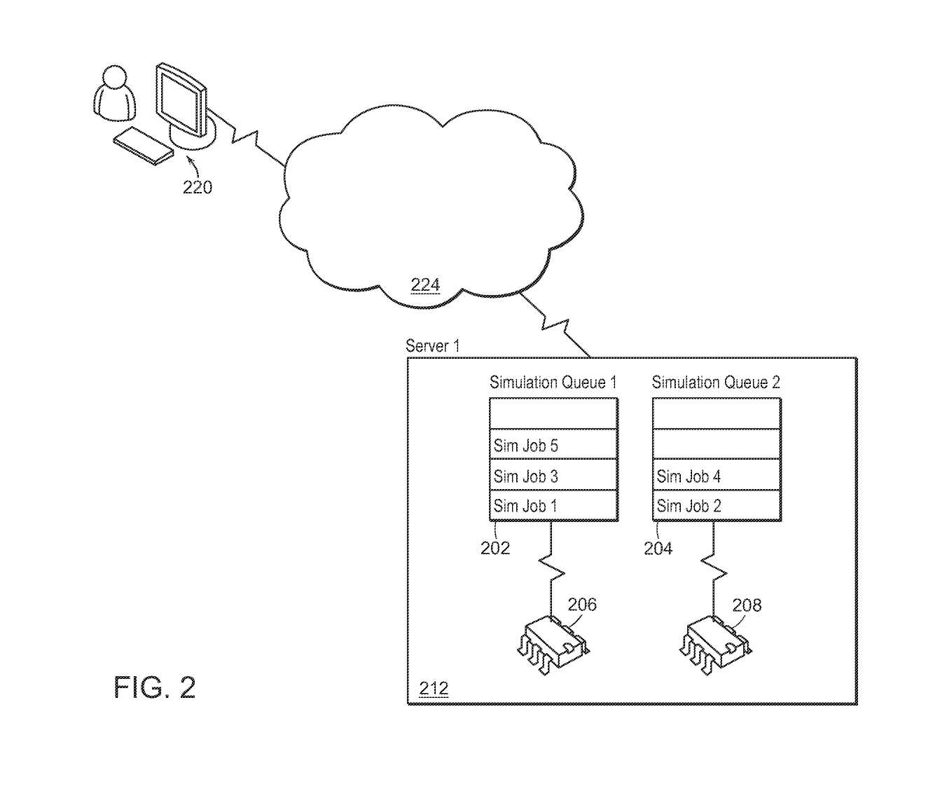

An annotation or group shape 4k allows users to attach a textual description to any of the preceeding shapes. By use of these shapes, users can collaboratively create and edit business process models with the interface provided by BPA server 112 or 114. BPA servers 112 and 114 are shown in more detail in FIG. 2.

In some embodiments, each process model designed in the user interface must have at least a start workstep, one or more activity worksteps, and at least one end workstep. The rest of the shapes are used according to the process sought to be modeled. Any user of the BPA system with appropriate access rights can view and edit the business process model by means of the user interface. In creating a simple process model, a user would first drag a Start shape 4a from a shapes listing onto a blank process model. Next, a workstep is included. An Activity shape 4b may then be placed in the process model to represent a workstep performed, for example, by a human user, group of human users, or a subprocess. At this point, more activity shapes 4b may be added as required to accurately model the business process. Finally, an End shape 4h is dragged onto the business model diagram. For more complicated process models, gateways may be used.

At some point during the placement of shapes, or upon completion of the placement of shapes, the user connects the worksteps in order to indicate the direction of the workflow. In order to connect worksteps in this manner, a user points to the shape representing the start of the work flow and selects one of 4 connection points that will appear in the user interface. An exemplary depiction of an icon providing the 4 connection points is shown as icon 41 in FIG. 4.

After a connection for a workstep has been established, a user is allowed to specify the type of connection that is to be employed. In addition to a standard connection type, representing a normal flow between worksteps, other connection types are provided. Such an additional connection type includes a compensation type, which is used in the event of an error during the process simulation. Compensation flow undoes all process changes up to the point of failure. Additionally, a timeout connection is available for use in the event of a process timeout. By using these shapes and connectors, the workflow can be defined for the process model.

The BPA system provides dataslots, which are used to manage information flow within a business process model. Dataslots are global variables in process models that enable the process to support the exchange of data across worksteps. Typically, a dataslot is defined as the output of one workstep and the input of the successor workstep. Information, in this case the value of the dataslot, is therefore passed from one workstep to the next workstep. In some embodiments, four types of dataslots are supported within the BPA system: string, number, Boolean and date-formatted. The string dataslot type contains a text string, which is the default dataslot configuration. A number dataslot type contains a numerical value, a Boolean dataslot type contains a true or false value, and a date dataslot type contains data representing a date value. The user interface provides users at clients 100-110 with the functionality to add, modify, or remove a dataslot for any given workstep in the business process model.

Business process models can also have details associated with the process. The collaborative, cloud-based nature of the BPA system allows any user with appropriate access privileges to contribute information defining process details. Specifically, users can add comments regarding the process. Users can review previously added comments, which also identify the author of the comment. Users also can attach documents to the process, visible by all users with appropriate privileges. Such documents may provide additional detail on the process, serve as a manual describing the underlying real world functionality, or the like. Finally, industry or domain-specific information can be configured for the process in the form of attributes. Like the other details, this domain-specific information is editable or readable by those users with appropriate access privileges.

An activity workstep can, in some embodiments, be performed as a subprocess workstep by another process or by a logical set of activities. A subprocess workstep provides the ability to nest a complete process model into another process model. An inline subprocess is a grouping of a set of activities into a logical group. The inline subprocess is stored as a part of the main process, and cannot be reused across processes. An inline subprocess is useful when designing a process model with a large number of worksteps, to group a related set of activities into an inline subprocess that can be referenced from the main process. In some embodiments, individual or multiple worksteps in a process can be converted into an inline subprocess workstep as long as the worksteps being converted have a single input and a single output flow.

Alternatively, a logical set of activities can be stored externally as a separate process model as a linked subprocess. A linked subprocess can be reused across multiple processes. For example, a “customer credit rating” subprocess containing worksteps to determine the credit rating for a customer might usefully be created as a linked subprocess, so that it is accessible by multiple processes.

A workstep can have properties or details associated with it. Details may include a name for a workstep, a defined performer of a workstep, a priority (e.g., low, medium, high, or critical) of a workstep, a duration in which a workstep needs to be completed, a description of the workstep, dataslots assigned to the workstep, and whether the workstep should execute multiple times (or “loop”).

### Sharing Business Process Models

In order to permit collaboration, a user who has created a process model shares the model with other users. The model can be shared with “read-only” (or view) or “read-write” (or modify) permission. Once shared, other users granted permission (which may be all users of the BPA system) can view the process model. Users granted “view” permission can only view the model without making modifications. Users granted “modify” permission can view and edit the process model. The user who created the process model can assign the same sharing permission to all users or may select users to be provided no sharing privileges, view privileges, or modify privileges.

As each new version of a process model is stored in process repository 120 within content management system 118, it is provided a new version number. Each user of the BPA system can (subject to permission privileges for the particular process model) view the revision history of the process model, convert a particular version to replace the latest version of the process model, take a snapshot of the process model to create a local version, or create a new process from a particular version of a process model. Additionally, a process model may be printed, imported from an XML Process Definition Language (XPDL)-supported modeling tool, or exported. A process model may be exported in XPDL format to an external modeling tool, or may be exported in for example an HTML or Excel format to generate process documentation. Further, a user may search processes stored in the system. In other embodiments, other export standards, such as Business Process Model and Notation (BPMN) 2.0, may be used.

### Simulations

FIG. 2 shows a client 220 connected via network 224 to BPA server 212, akin to BPA servers 112 and 114 in FIG. 1. In addition to providing the aforementioned user interface for process modeling, the BPA servers can run simulations based on process models designed in the BPA system. The servers each maintain dynamic queues of simulation jobs, organized in a first-in first-out (FIFO) fashion. BPA server 212 contains simulation queues 202 and 204. Each simulation queue is assigned to a processor 206 or 208, respectively. Each simulation queue may also be assigned to a processor core if processors 206 or 208 are multi-core processors. The number of processors used in BPA system 140 is determined by the specific implementation. In this embodiment, each simulation queue has a dedicated processor with a single core, and therefore the number of simulation queues in BPA server 212 is equal to the number of processors available to run simulations in BPA server 212. The number of processors dedicated for simulation is determined by the current server work load and may be varied. Simulation jobs submitted by users at client 220 or at other clients connected to server 212 are added to simulation queues 202 and 204 in round-robin fashion. Other scheduling algorithms, such as first-come first-served or weighted fair queueing, may be used in certain embodiments, and priority can be provided to simulations from particular users or groups, or for particular types of business process models. In some embodiments, clusters of servers are employed, and one or more servers can be designated as simulation servers. All processors in a simulation server are assigned simulation jobs, and simulation requests are assigned to simulation servers in accordance with a load balancing algorithm that can be implemented in hardware or software, or using for example a proxy server. In other embodiments, multiple simulation queues are assigned to a single processor or a single queue may be associated with multiple processors. Although two simulation queues are shown in FIG. 2, it should be understood that any appropriate number of queues may be used.

In order to run a simulation, it is first configured. The user will configure when the simulation will start and stop, and/or its duration. Additionally, the user can define the days and times during which performers work. The user also will determine the number of instances of a process to be created and the duration of each interval between process instances. Additionally, settings for individual worksteps can be configured, such as specific resources to be assigned to or used during the workstep. Further, probabilities can be set to determine which of multiple outgoing links from an activity workstep is selected, or which path from a decision gateway is selected.

Simulations can be used in a number of ways to aid in process improvement. For example, simulations can identify bottlenecks. In a simulation, as discussed above, resources are assigned to worksteps. Resources may be a customer support executive or team for activity worksteps. The simulation designates a resource as unavailable during the execution of a workstep, and releases the resource when the workstep is completed. Bottlenecks occur when another workstep needs the same resource and must wait for the resource to be released.

Further, the BPA system allows users to define metrics in order to better achieve goals for optimum time, cost, and resource utilization within the process model. These metrics can be defined at the process and workstep levels, as well as defined for performers and resources. Any violation of these metrics, as determined during a simulation based on the business process model, can be reported to the user at the end of a simulation. In some embodiments, a wide variety of metrics are supported by the BPA system. For example, instance creation count and instance completion count set the number of instances created for a process or workstep, and the number of completed instances for a process or workstep, respectively. An instance terminated count metric provides information on the number of instances that were terminated during simulation for a given process or workstep. An aggregate completion time metric sets the total completion time of all instances for a given process or workstep. An average completion time, similarly, sets the average completion time for all instances of a process or workstep. A total task count metric sets the total count of tasks performed by one specific performer. Total usage duration and total cost metrics respectively set the total duration of tasks performed by a performer, as well as the total cost of a performer or resource. An average cost per task metric defines the cost of each performer for each completed task. Total count and average cost metrics are provided to set the total count of a consumable resource available in the model, as well as the average cost of any non-consumable resources used within the model. A total invocations metric is provided to set the number of invocations, and a traversal count metric sets the total count for traversing a specific path within the process model. The summed traversal time and average traversal time define the total time for traversing a path for all process instances, as well as the average time for traversing a path for all process instances. By use of these metrics, users can more accurately define the constructed business process model in anticipation of later simulation. Of course, additional or alternative metrics also may be used as appropriate for a particular business process.

### Cooperation and Collaboration

Collaboration server 116 also provides functionality to facilitate user coordination and cooperation while collaboratively developing business process models. In some embodiments, an interactive, informational web page is provided for each process model that provides access to all relevant information regarding a business process model. Any changes to the state of the process are automatically reflected on this page. The site includes a listing of the latest changes to the process, similar to an RSS feed. This includes the latest updates to the process model and any user-submitted comments or documentation. These entries also identify the user who applied the change, as well as the time that the change was applied. Additionally, the page contains a wiki that allows any authorized user to edit the content of various sections, or add new material. The sections may include images, links to other relevant documents, simulation reports and the like. The page also supports user discussion threads, maintaining comments from users on the process and its components. These discussions are organized into threads, which store the history of the discussion. Additionally, the page supports attaching documents to the process or any of its associated worksteps. The page also may include training materials for the process, issue escalation procedures, issue resolutions, reference information, and frequently asked questions (FAQ). The page is administered by the owner of the business process model, who can control access rights for the users. The site can also be archived and exported for review by users who do not have privileges in the BPA system.

Users with appropriate access permissions can view, in the user interface, the history of each process model. Content management system 118 provides the ability for the user to view the revision history of each process model, to convert a particular version of the model to replace the latest version, to create a user's own unique copy of the process model version by taking a snapshot of the process model, or to create an entirely new process model from the selected process model version.

The BPA system also includes a chat facility to permit users to chat with other users, such as to collaborate on process improvements. Chats can occur on an individual or group basis.

In some embodiments, the business process model is stored using Java classes. The Java classes are cross compiled to javascript for use in the user's browser and Java bytecode for use in BPA server 112 or 114.

In addition to storing prior versions of the collaboratively developed process models, content management system 118 stores simulation results run on these process models. Reports generated from these simulation results are available to authorized users within the BPA system.

### Executing Simulations

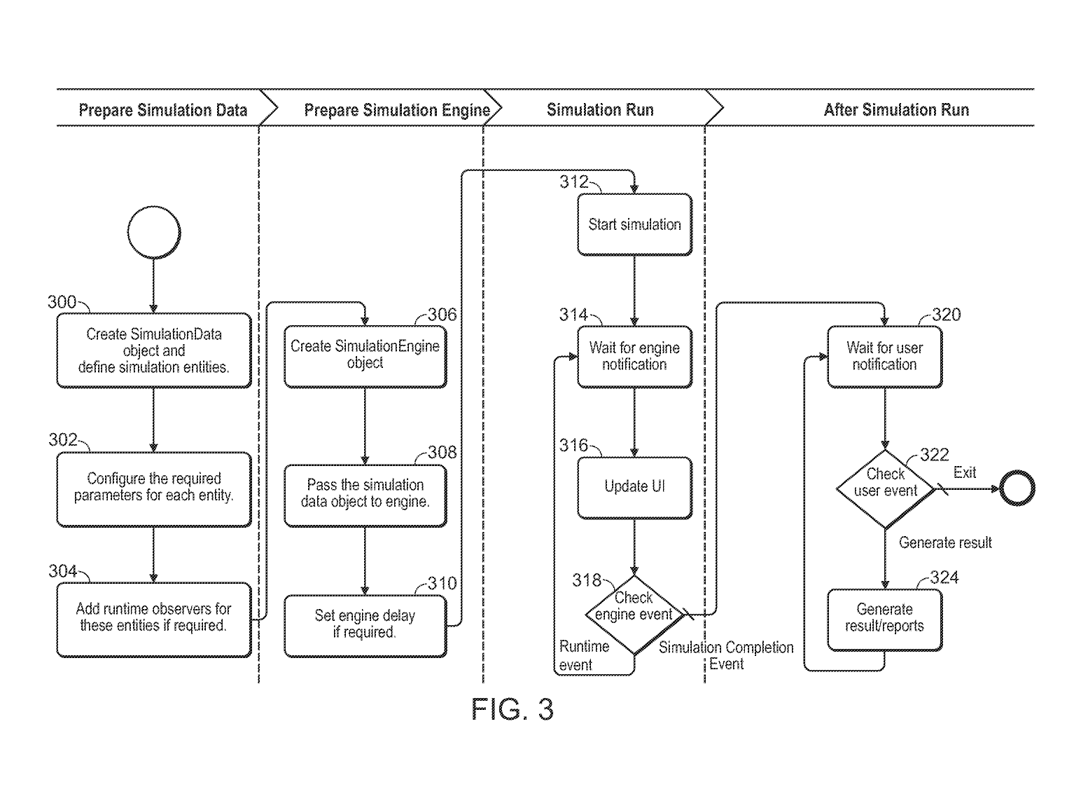

FIG. 3 shows the steps performed by BPA servers when running simulations based on the user's business process model, in accordance with some embodiments. To begin a simulation, a user sends a simulation request to a server specifying the business model on which to perform the simulation. In response, the server will prepare the simulation data. This process begins at step 300, where a simulation data object is created on the BPA server. This data object specifies and defines the entities present in the simulation, and in some embodiments is created as a Java class capable of storing configuration information related to the simulation. In other embodiments, other implementation constructs may be used. Next, the parameters of the simulation are configured for each of the entities defined by the simulation data object as shown in step 302. In step 304, runtime observers are created for each of these entities if required. A runtime observer is used by the BPA system to notify users of progress within the simulation. Once the simulation data is prepared, the simulation engine preparation begins.

The simulation engine that runs on the BPA servers may be a Java class or other implementation construct that manages the simulation and its output. Following the set-up described in steps 300-304, the server creates a simulation engine object in step 306. In step 308, the simulation data required to run the simulation is passed to the simulation engine created in step 306. In step 310, an engine delay is configured if required by the simulation. An engine delay allows users to observe what is happening during the execution of the simulation within the browser user interface. This delay is typically in milliseconds, and allows a delay in execution such that the user interface can reflect the state of the simulation in a way observable by users. Once the delay is configured, the simulation is scheduled for execution.

At this point, the actual simulation can be started and executed. Execution of the simulation begins at step 312. Steps 314, 316 and 318 depict the looped process of waiting for engine notification to proceed with the next workstep, processing the runtime event and determining if the simulation is complete, and updating the user interface with the simulation's progress. After each runtime event is processed in step 316 and the user interface updated in step 318, control returns to step 314 to wait for engine notification. If more runtime events exist in the simulation, control proceeds in this looped manner from steps 314-318. If a simulation completion event is detected at step 318, the system is signaling that the simulation is complete and indicating that control should move to step 320.

Step 320 begins the processing that occurs after a simulation run is complete. In step 320, the user waits for notification of the simulation completion event. Once received, control passes to step 322, which checks user initiated events to determine if the simulation should be exited, or whether reports should be generated from the simulation results. If a report is to be generated, control passes to step 324 where the report is generated. Control passes among steps 320, 322 and 324 in this manner as long as user events exist in the processing queue.

Upon completion of a simulation run, simulation results and their associated simulation scenario are stored in content management server 118. Key attributes of the simulation results, including identification of process bottlenecks, failed objectives and the like, are stored as simulation result metadata. The user responsible for submitting the simulation is notified upon successful submission of the results to the content management system. As a result of the simulation, the BPA system of FIG. 1 can generate reports with interactive graphics highlighting time, cost, and resource utilization in the business process model. The reports also include any violations of defined process objectives in order to assist users with further optimization of the process model in order to achieve the desired goals. These reports can also be exported in a variety of formats, such as Excel and HTML. Rules directing the automatic publishing of the simulation reports may be defined by the users at clients 100-110 as well. For example, a rule could be created in order to automatically publish reports generated from simulation results with fewer than two bottlenecks. Comparison reports may also be generated from different simulation results or imported real-world data. Finally, a replay function causes the simulation to be replayed after completion for observation by users of the BPA system.

The logic and functionality of the BPA systems and components described herein can be implemented in software, which can be provided on a variety of computer readable media, including magnetic and optical disks, or a flash drive.

Although the present invention has been described and illustrated in the foregoing exemplary embodiments, it is understood that the present disclosure has been made only by way of example, and that numerous changes in the details of implementation of the invention may be made without departing from the spirit and scope of the invention. The invention is limited only by the claims that follow.

What is claimed is:

1. A system of providing collaborative business process analysis, the system comprising:
a set of one or more servers programmed to provide a user interface for a plurality of clients,
the user interface programmed to permit the creation and editing of a business process model, and
the user interface further programmed to permit a plurality of users to edit the same business process model simultaneously; and
the set of one or more servers further programmed to store business process models in a content management system.

2. The system of claim 1, wherein the set of one or more servers includes a first server in communication with a second server, wherein the first server is programmed to provide the user interface and the second server is programmed to store business process models in the content management system.

3. The system of claim 2, wherein the first server is in communication with the second server over a local area network.

4. The system of claim 2, wherein the first server is in communication with the second server over the Internet.

5. The system of claim 2, wherein the first server is in communication with the second server through a cloud computing platform.

6. The system of claim 2, wherein each of the plurality of users has specified access rights to business process models on a user or a group basis.

7. The system of claim 2, wherein the user interface is programmed to periodically poll the first server to obtain changes to the business process model made by the plurality of users.

8. The system of claim 2, wherein the first server is programmed to push changes to the business process model to the user interface.

9. The system of claim 2, wherein the first server is programmed to validate changes to the business process model.

10. The system of claim 2, wherein the set of one or more servers further comprises a third server programmed to store a sequence of changes to the business process model.

11. The system of claim 10, wherein the user interface is programmed to send to the third server edits to the business process model to be stored as a sequence of changes to the business process model.

12. The system of claim 11, wherein the second server is programmed to store a sequence of versions of the business process model in the content management system, and wherein the third server is programmed to clear the stored sequence of changes to the business process model when a new version of the business process model is stored in the content management system.

13. The system of claim 2, wherein the second server is programmed to store a sequence of versions of the business process model in the content management system.

14. The system of claim 2, wherein the user interface permits the plurality of clients to store local copies of the business process model in memory of the client.

15. The system of claim 2, wherein the user interface is programmed to permit one or more of the plurality of clients to execute on the first server a simulation using the business process model.

16. The system of claim 2, wherein the user interface is programmed to permit a first of the plurality of users to share the business process model with a second of the plurality of users.

17. The system of claim 2, wherein the user interface is programmed to permit the creation and editing of the business process model through a drag and drop process.

18. The system of claim 2, wherein the user interface is further programmed to provide an interactive work site providing information regarding the business process model.

19. The system of claim 18, wherein the interactive work site includes a listing of changes to the business process model.

20. The system of claim 18, wherein the interactive work site includes documentation regarding the business process model.

21. The system of claim 2, wherein the first server is programmed to provide the user interface through a web browser.

22. The system of claim 2, wherein the first server is programmed to run simulations based on the business process model.

23. The system of claim 22, wherein the first server includes a plurality of simulation queues, each simulation queue for queuing simulation jobs submitted through the user interface.

24. A method for synchronizing changes to a business process model across a plurality of clients, the method comprising:
in response to a first user applying a first change to a business process model, receiving at a first server a command to update the business process model;
synchronizing a first local copy of the business process model with a version of the business process model stored in a content management system;
determining a validity of the first change to the business process model against the synchronized first local copy of the business process model; and
if the first change is determined to be valid, providing a first new version of the business process model incorporating the first change to the content management system.

25. The method of claim 24, further comprising:
in response to a second user applying a second change to the business model, receiving at a second server a command to update the business process model;
synchronizing a second local copy of the business process model with a version of the business process model stored in the content management system;
determining a validity of the second change to the business process model against the synchronized second local copy of the business process model; and
if the second change is determined to be valid, providing a second new version of the business process model incorporating the second change to the content management system.

26. The method of claim 25, wherein:
if the first change is determined to be valid and the second change is determined to be valid, the second new version of the business process model includes the first change and the second change; and
if the first change is determined not to be valid and the second change is determined to be valid, the second new version of the business process model includes the second change and does not include the first change.

27. A method for running simulations on a computer system based on a business process model, the method comprising:
sharing a business process model with a plurality of users;
receiving a request to perform a simulation on the shared business process model;
preparing simulation data in response to the received simulation request;
configuring parameters of the simulation;
creating a simulation engine object;
passing the simulation data to the simulation engine object;
processing a series of worksteps to execute the simulation and generate simulation results; and
storing the simulation results.

28. The method of claim 27, further comprising generating a report of the simulation results.

29. The method of claim 28, wherein generating a report of the simulation results includes generating a report indicative of resource utilization.

30. The method of claim 28, wherein generating a report of the simulation results includes providing a suggestion of corrective action in response to the simulation results.

31. The method of claim 27, wherein configuring parameters for the simulation includes configuring one or more periods during which one or more performers being simulated work.

32. The method of claim 27, wherein configuring parameters for the simulation includes configuring a number of instances of a process to be created during the simulation.

33. The method of claim 27, wherein configuring parameters for the simulation includes configuring one or more specific resources to be assigned or used during a workstep to be executed within the simulation.

34. The method of claim 27, wherein configuring parameters for the simulation includes assigning probabilities for which of a plurality of paths from a workstep is selected during the simulation.

35. The method of claim 27, further comprising creating one or more runtime observers to provide a notification of progress within the simulation.
